(19) United States
(12) Patent Application Publication
(10) Pub. No.: US 2016/0123538 A1
(43) Pub. Date: May 5, 2016

(54) PRESSURE CONTAINER

(71) Applicant: YACHIYO INDUSTRY CO., LTD., Sayama-shi, Saitama (JP)

(72) Inventor: Kazuhiro Nakamura, Saitama (JP)

(21) Appl. No.: 14/895,265

(22) PCT Filed: May 7, 2014
(86) PCT No.: PCT/JP2014/062278

§ 371 Date: Dec. 2, 2015

(30) Foreign Application Priority Data
Jun. 6, 2013 (JP) 2013-119749

(51) Int. Cl. F17C 13/06; F17C 1/02

(52) U.S. Cl. CPC F17C 13/06; F17C 1/02; F17C 2203/0604; F17C 2203/0619; F17C 2260/012

(57) ABSTRACT

A pressure container including: a liner that is formed by blow molding and has a storage portion storing liquid or gas and a filler neck in a cylindrical shape protruding from the storage portion; a mouthpiece that has an embedded portion embedded in a circumferential direction by the filler neck being folded inward in a radial direction at an end portion, and an exposed portion that is formed continuously from the embedded portion to be exposed as an inner wall of the filler neck; a mounting member that is mounted inside the exposed portion in the radial direction; and a seal member that seals a gap between the filler neck and the mounting member.

### TECHNICAL FIELD

The present invention relates to a pressure container that stores gas or liquid.

### BACKGROUND ART

A pressure container has been known to store high pressure gas or liquid. In recent years, for the purpose of weight reduction of the pressure container, a multilayer pressure container has been proposed in which a thin wall container (liner) made of synthetic resin is covered by a reinforcing layer with resin-impregnated fiber and subsequently the resin is hardened.

For example, a pressure container disclosed in Patent Document 1 is formed by a liner having a projecting filler neck, a mouthpiece provided outside the liner, and a fiber-reinforced resin layer (FRP layer) that covers the liner and the mouthpiece. The inner circumferential face of the cylindrical portion of the mouthpiece is formed with, for example, a female thread, and fastening a valve to the female thread allows the gas or liquid to be injected into/ejected from the pressure container through the valve.

### PRIOR ART DOCUMENT

### Patent Document

Patent Document 1: Japanese Patent Application Publication No. 2009-058111 A

### SUMMARY OF THE INVENTION

### Problem to be Solved by the Invention

The material of the liner is different from that of the mouthpiece, and this makes it difficult to join these members without a gap so as not to leak the gas or liquid. On the other hand, if a seal structure is complicated to prevent the leak, there might be problems such as complex manufacturing operations and increase in manufacturing cost. Further, since the filler neck of the liner is made of resin, the filler neck may be easily worn by degradation overtime to give adverse affects to sealing property.

The present invention is invented in order to solve such problems to provide a pressure container that has a simple structure to allow for reliable sealing.

### Means for Solving the Problem

To solve the above problems, the present invention provides a pressure container having: a liner that is formed by blow molding and that includes a storage portion storing liquid or gas and a filler neck in a cylindrical shape protruding from the storage portion; a mouthpiece that includes an embedded portion embedded in a circumferential direction by the filler neck being folded inward in a radial direction at an end portion, and an exposed portion that is formed continuously from the embedded portion to be exposed as an inner wall of the filler neck; a mounting member that is mounted inside the exposed portion in the radial direction; and a seal member that seals a gap between the filler neck and the mounting member.

Further, the present invention provides a pressure container having: a liner that is formed by blow molding and includes a storage portion storing liquid or gas and a filler neck in a cylindrical shape protruding from the storage portion; a mouthpiece that includes an embedded portion embedded in a circumferential direction by the filler neck being folded inward in a radial direction at an end portion, and an exposed portion that is formed continuously from the embedded portion to be exposed as an inner wall of the filler neck; an attachment member that is fitted on the end portion of the filler neck in the circumferential direction; a mounting member that is mounted inside at least either one of the attachment member and the exposed portion in the radial direction; and a seal member that seals a gap between the filler neck and the attachment member.

According to the structure, the embedded portion of the mouthpiece is formed inside the end portion of the filler neck, which can be easily worn, in the circumferential direction, and the exposed portion of the mouthpiece is arranged as the inner wall of the filler neck. This reinforces the filler neck. Reinforcing the filler neck allows for securely sealing a gap between the filler neck and the mounting member or the attachment member. Further, a structure can be simple because all that is required is the embedded portion and the exposed portion inside the filler neck. Still further, using the attachment member allows for attaching to various kinds of mounting members.

Further, a seal member is preferably arranged to seal a gap between the exposed portion and the mounting member. Still further, a seal member is preferably arranged to seal a gap between the exposed portion and the attachment member. Yet further, a seal member is preferably arranged to seal a gap between the attachment member and the mounting member.

According to the structure, seal performance can be further improved by arranging the seal members in various places.

### Effect of the Invention

The pressure container according to the present invention allows for reliable sealing with a simple structure.

### BRIEF DESCRIPTION OF DRAWINGS

FIG. 1 is a partially-cutaway sectional side view of a pressure container according to a first embodiment of the present invention;

FIG. 2 is a sectional side view showing an enlarged main portion of the pressure container according to the first embodiment;

FIG. 3 is a perspective view of a mouthpiece according to the first embodiment;

FIG. 4 is a schematic sectional view showing an arrangement process and a mold clamping process of the manufacturing method for the pressure container according to the first embodiment;

FIG. 5 is a schematic sectional view showing a blow process of the manufacturing method for the pressure container according to the first embodiment;

FIG. 6 is a sectional side view showing an enlarged main portion of the pressure container according to a modification of the first embodiment;

FIG. 7 is a sectional side view showing an enlarged main portion of the pressure container according to a second embodiment of the present invention;

FIG. 8 is a perspective view of the mouthpiece according to the second embodiment;

FIG. 9 is a perspective view of an attachment member according to the second embodiment;

FIG. 10 is a sectional view showing the enlarged main portion of the pressure container according to a first modification of the second embodiment;

FIG. 11 is a sectional view showing the enlarged main portion of the pressure container according to a second modification of the second embodiment; and

FIG. 12 is a sectional view showing the enlarged main portion of the pressure container according to a third modification of the second embodiment.

### BEST MODE FOR CARRYING OUT THE INVENTION

### First Embodiment

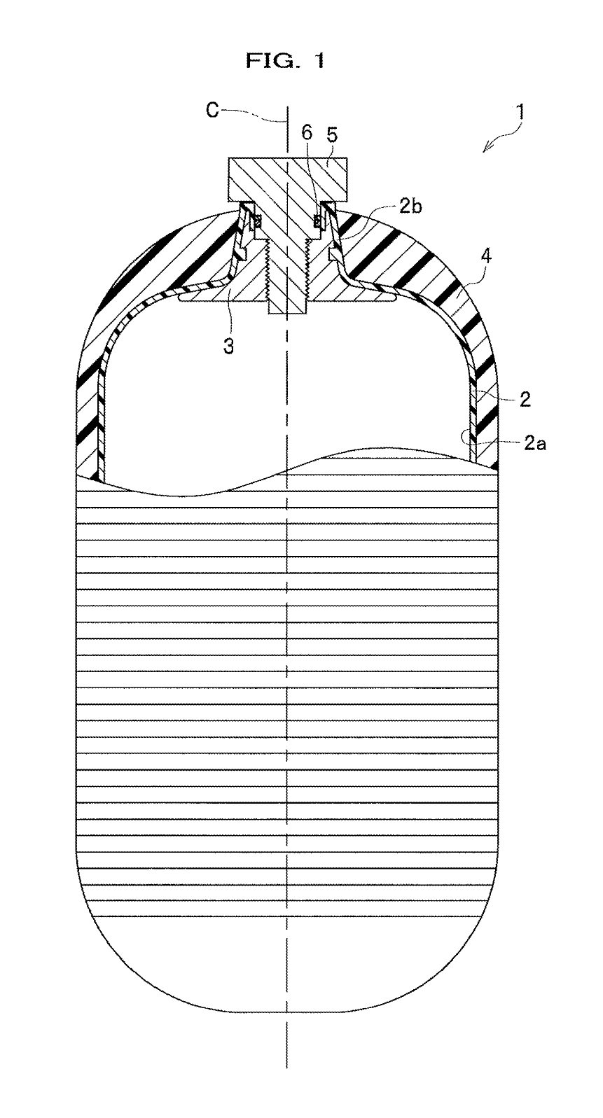

Embodiments of the present invention will be described in detail with reference to drawings. As shown in FIG. 1, a pressure container 1 according to the present embodiment is mainly formed with a liner 2, a mouthpiece 3 attached to the end of the liner 2, a reinforcing layer 4 covering the outer circumference of the liner 2, a valve 5 attached to the mouthpiece 3, and a first seal member 6. The pressure container 1 is, for example, a container capable of storing liquid or gas therein.

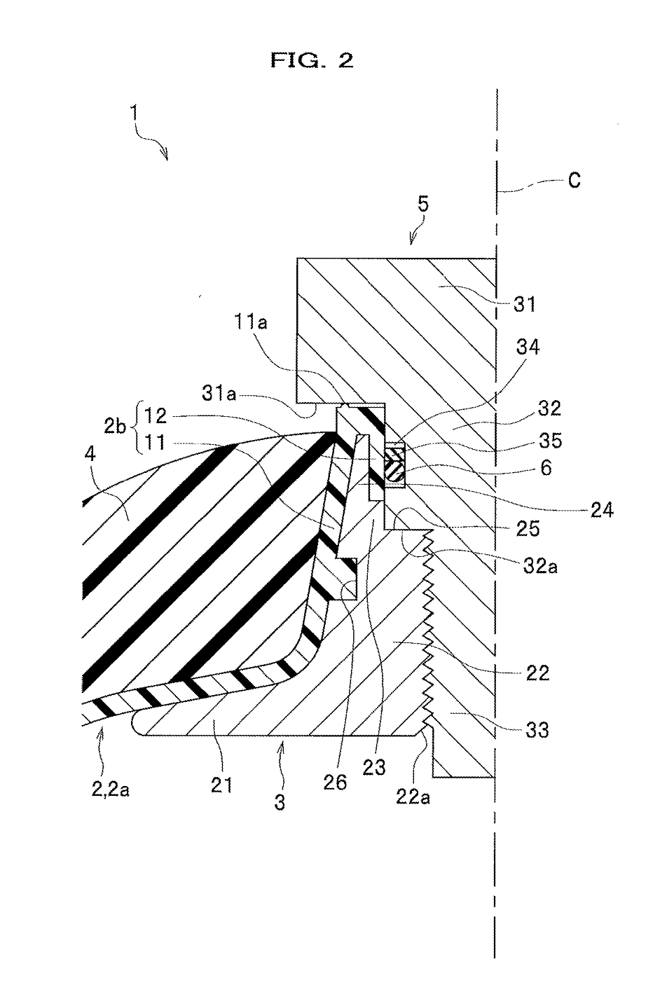

As shown in FIGS. 1 and 2, the liner 2 is made of resin and is hollow inside. Though the material of the liner 2 is not particularly limited, polyethylene (PE), high density polyethylene (HDPE), polyamides, polyketones, or polyphenylene sulfide (PPS) is used, for example, depending on the type and application of contained gas or liquid. Forming the liner 2 with resin allows for weight reduction.

In this embodiment, the liner 2 is formed with a storage portion 2a for storing the liquid or gas and a filler neck 2b that continues to the storage portion 2a and protrudes outward along the center axis C direction. The shape of the storage portion 2a is not particularly limited, and may be, for example, spherical.

As shown in FIG. 2, the filler neck 2b is formed with a neck portion 11 that is continuous to the storage portion 2a and in a cylindrical shape, and a folded portion 12.

The neck portion 11 is in contact with outer circumferential faces of a base portion 22, an intermediate portion 23 and an embedded portion 24 to be described later. The neck portion 11 is inclined to be closer to the center axis C with the increasing distance from the storage portion 2a. A protrusion 11a is formed at the top end of the neck portion 11. The protrusion 11a is formed continuously along the circumferential direction on the top end face of the the neck portion 11.

The folded portion 12 has an L-shaped cross section and is extended from the top end (end portion) of the neck portion 11 toward the storage portion 2a. The folded portion 12 is in contact with the top end face and the inner circumferential face of the embedded portion 24 to be described later.

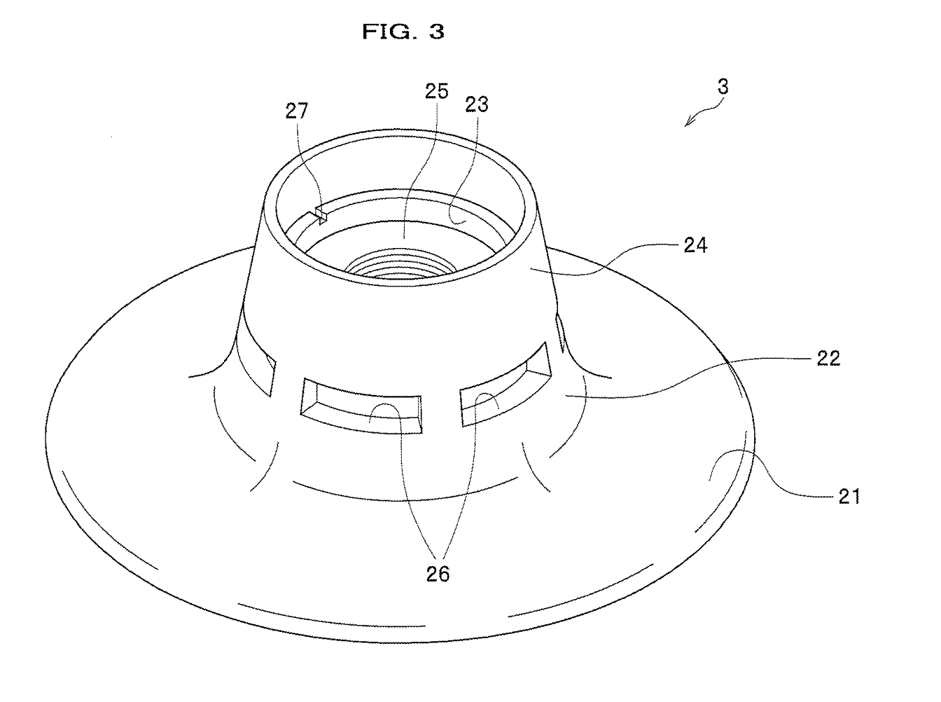

As shown in FIGS. 2 and 3, the mouthpiece 3 is a metal member arranged radially inside the liner 2. The mouthpiece 3 is mainly formed with a flange 21, the base portion 22, the intermediate portion 23 and the embedded portion 24.

The flange 21 has an annular shape. The base portion 22 has a cylindrical shape and is extended from the inner edge of the flange 21. A female thread is formed in the inner circumferential face of the base portion 22. A plurality of grooves 26 are formed along the circumferential direction on the outer circumferential face of the base portion 22. The resin for forming the liner 2 later penetrates into the grooves 26 to regulate the relative rotation to the filler neck 2b and the movement in the center axis C direction of the mouthpiece 3.

The intermediate portion 23 has a cylindrical shape and is formed on the top end face of the base portion 22. The intermediate portion 23 is thinner than the base portion 22. The intermediate portion 23 has a larger inner diameter than the base portion 22. The stepped portion between the base portion 22 and the intermediate portion 23 forms a stepped face 25. As shown in FIG. 3, a plurality of grooves 27 along the radial direction are formed in the top end face of the intermediate portion 23 (only one groove is shown in FIG. 3). The resin for forming the liner 2 later penetrates into the grooves 27 to regulate the relative rotation of the mouthpiece 3 to the filler neck 2. It is noted that an “exposed portion” in claims is formed with the base portion 22 and the intermediate portion 23.

The embedded portion 24 has a cylindrical shape and is formed on the top end face of the intermediate portion 23. The embedded portion 24 is thinner than the intermediate portion 23. The embedded portion 24 has a larger inner diameter than the intermediate portion 23. As shown in FIG. 2, the radially outer and inner faces and the top end of the embedded portion 24 are covered continuously by the neck portion 11 and the folded portion 12 in the circumferential direction.

The reinforcing layer 4 is made of FRP (fiber reinforced plastic) and is formed to cover the outer circumferential face of the liner 2. The reinforcing layer is not limited to the fiber reinforced resin, and may be made of other materials that can improve the strength of the liner 2.

As shown in FIG. 2, the valve 5 is inserted in the filler neck 2b of the liner 2 and the mouthpiece 3. The valve 5 is formed with a main portion 31, a middle diameter portion 32 and a small diameter portion 33. The valve 5 corresponds to a “mounting member” in claims. The “mounting member” is any member that is fastened to at least one of the filler neck 2b and the mouthpiece 3, and may be, for example, a joint member.

An end face 31a of the main portion 31 is in contact with the protrusion 11a. The middle diameter portion 32 has a smaller outer diameter than the main portion 31. The outer diameter of the middle diameter portion 32 is substantially the same as the inner diameter of the folded portion 12. A recess 34 is formed along the circumferential direction on the outer circumferential face of the middle diameter portion 32. The recess 34 is used as a mounting seat for the first seal member 6. An end face 32a of the middle diameter portion 32 is in contact with the stepped face 25.

The small diameter portion 33 has a smaller outer diameter than the middle diameter portion 32. A male thread is formed on the outer circumferential face of the small diameter portion 33, to be screwed into the female thread of the base portion 22.

The first seal member 6 is an O-ring and is arranged in the recess 34. The first seal member 6 is used to seal a gap between the filler neck 2b and the valve 5. The first seal member 6 specifically abuts on the folded portion 12 and the middle diameter portion 32. The first seal member 6 is arranged to be overlapped with the folded portion 12 and the embedded portion 24 in the center axis C direction. In the present embodiment, a backup ring 35 is arranged adjacent to the first seal member 6.

Next, a method of manufacturing the pressure container according to the present embodiment will be described. The pressure container according to the present embodiment is manufactured by blow molding. The manufacturing method of the pressure container includes an arrangement process, a parison supply process, a mold clamping process, a blow process, a reinforcing layer forming process, and a component mounting process.

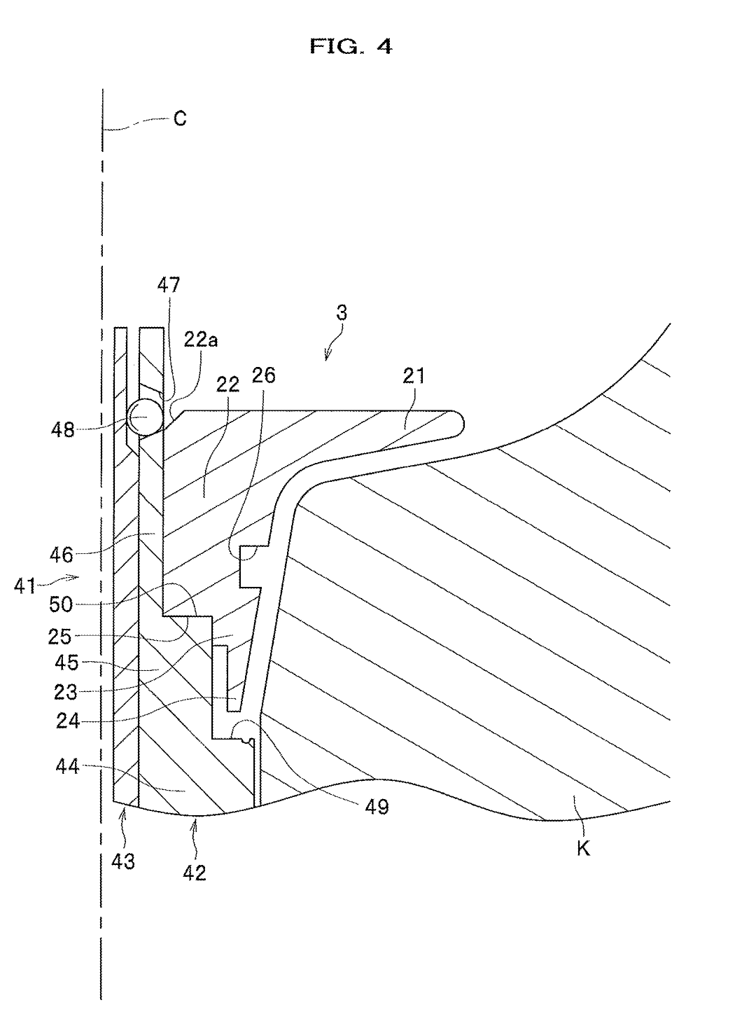

First, as shown in FIG. 4, a blow pin 41 will be described that is used in blow molding. The blow pin 41 includes an outer cylindrical portion 42 and an inner cylindrical portion 43 that is moved forward or backward with respect to the outer cylindrical portion 42. The outer cylindrical portion 42 includes a large diameter portion 44, a middle diameter portion 45 and a small diameter portion 46, each having a cylindrical shape. The outer diameter of the middle diameter portion 45 is substantially the same as the inner diameter of the intermediate portion 23. In addition, the outer diameter of the small diameter portion 46 is substantially the same as the inner diameter of the base portion 22.

A ball arrangement hole 47 penetrating in the radial direction is formed at the top end of the small diameter portion 46. A ball 48 is arranged in the ball arrangement hole 47. The stepped portion formed by the large diameter portion 44 and the middle diameter portion 45 forms a first stepped face 49. In addition, the stepped portion formed by the middle diameter portion 45 and the small diameter portion 46 forms a second stepped face 50.

In the arrangement process, as shown in FIG. 4, the mouthpiece 3 is arranged in the blow pin 41. Specifically, the mouthpiece 3 is inserted in the small diameter portion 46 so as to abut the second stepped face 50 on the stepped face 25 of the mouthpiece 3.

In the parison supply process, a tubular parison is supplied outside the blow pin 41 and between forming molds K, K. It is noted that, in FIG. 4, one of the forming molds and the parison are omitted for the purpose of illustration.

In the mold clamping process, mold clamping of the forming molds K is performed as shown in FIG. 4. The mold clamping allows for forming a cavity surrounded by the forming molds K, the mouthpiece 3, the first stepped face 49 and the middle diameter portion 45. The cavity causes the filler neck 2b of the liner 2 to be formed.

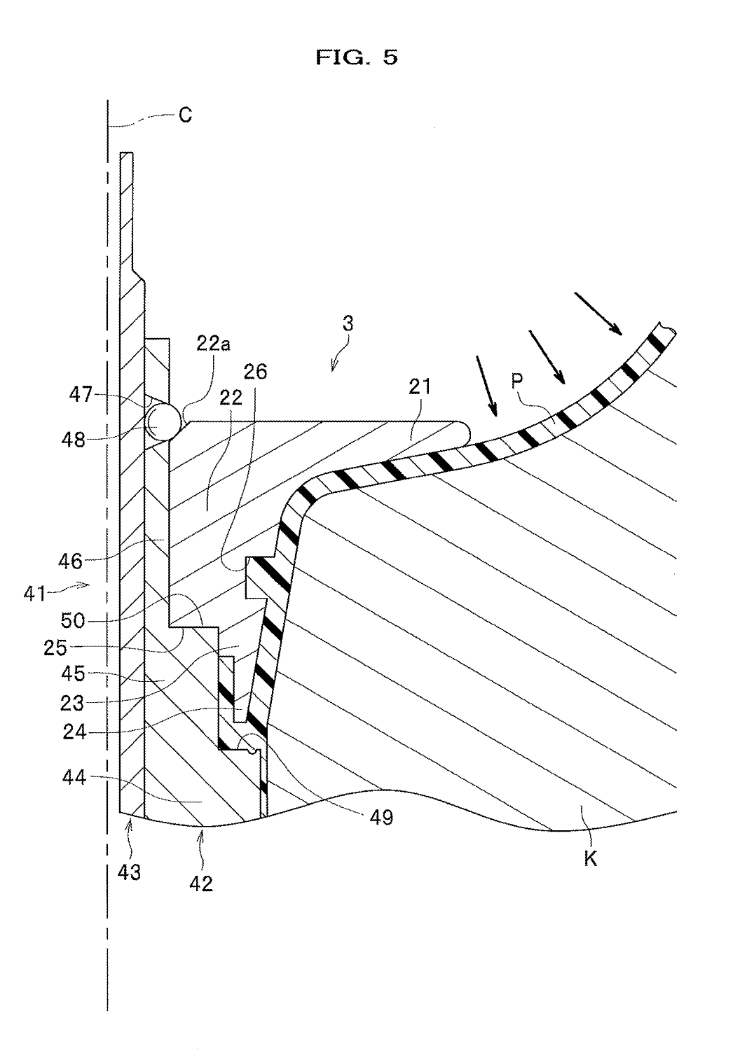

Further, in the mold clamping process, as shown in FIG. 5, the inner cylindrical portion 43 is moved forward with respect to the outer cylindrical portion 42. Accordingly, the ball 48 is moved from the ball arrangement hole 47 to be slightly projected from the outer circumferential face of the small diameter portion 46. The projected ball 48 is in contact with a chamfered face 22a of the base portion 22. Thus, this regulates the movement of the mouthpiece 3 in the axial direction with respect to the blow pin 41.

In the blow process, as shown in FIG. 5, air is supplied to the blow pin 41 to transfer the parison P onto the forming mold K. The parison P is a molten resin which is a material later to form the liner 2. The air pressure at the time of blow molding allows the parison P to flow, so that the cavity is reliably filled with the parison P.

After the blow process is completed, the blow pin 41 is moved backward outside the forming molds K so as to be removed. Thus, a combined member of the liner 2 with the mouthpiece 3 is formed.

In the reinforcing layer forming process, for example, the reinforcing layer 4 is formed on the outer circumference of the liner 2 and the mouthpiece 3 by a filament winding method.

In the component mounting process, the first seal member 6 and the backup ring 35 are arranged in the recess 34 of the valve 5 and the valve 5 is screwed in the mouthpiece 3. With the above processes, the pressure container 1 is formed.

According to the pressure container 1 as described above, the filler neck 2b is made of resin and protrudes, and therefore can be easily worn by aging degradation, however the embedded portion 24 of the mouthpiece 3 is embedded along the circumferential direction inside the end of the filler neck 2b and the exposed portion (the base portion 22 and the intermediate portion 23) of the mouthpiece 3 is formed as the inner wall of the filler neck 2b. Accordingly, the filler neck 2b is reinforced. The first seal member 6 is arranged at the position to seal the reinforced filler neck 2b, that is, at the position to be overlapped with the folded portion 12 and the embedded portion 24 in the center axis C direction, allowing the first seal member 6 to securely seal the gap between the filler neck 2b and the valve 5 for a long time. In addition, all that is required is to arrange the embedded portion 24 and the exposed portion inside the filler neck 2b, leading to a simple structure.

Also, according to the manufacturing method of the pressure container according to the present embodiment, all that is required is to arrange the mouthpiece 3 on the second stepped face 50 of the blow pin 41, and this can reduce operating time and manufacturing cost. Still further, the mouthpiece 3 is arranged to be interposed between the second stepped face 50 and the ball 48, allowing for preventing the mouthpiece 3 from floating at the time of the blow molding. Thus, the molding operation can be performed accurately.

### Modification

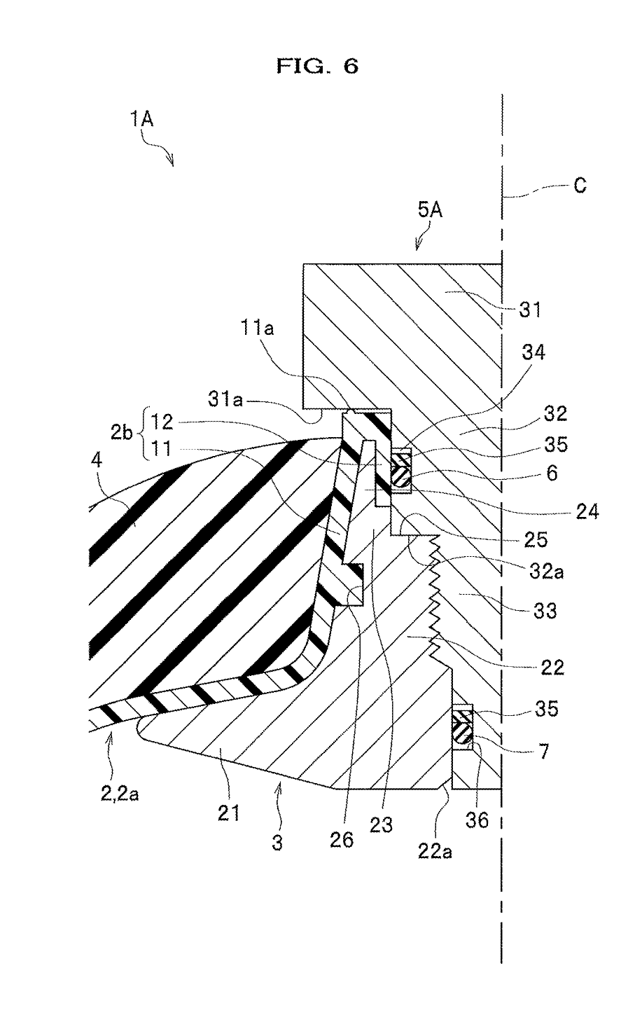

Next, a description will be given of a pressure container 1A according to a modification of the first embodiment, referring to FIG. 6. As shown in FIG. 6, the pressure container 1A differs from the first embodiment in that the pressure container 1A includes a second seal member 7 besides the first seal member 6. Since this modification is substantially the same as the first embodiment except the structure around the second seal member 7, the same portions will be denoted by the same reference numerals and the descriptions therefor will be omitted.

A female thread is formed on the inner circumferential face at the base end in the base portion 22 of the mouthpiece 3. In addition, the inner circumferential face at the top end is a flat face. The inner diameter of the inner circumferential face at the top end is smaller than the inner diameter at the base end.

The valve 5A is formed with the main portion 31, the middle diameter portion 32 and the small diameter portion 33. A male thread is formed on the outer circumferential face at the base end of the small diameter portion 33. The male thread on the valve 5A is screwed with the female thread formed at the base end of the base portion 22. A recess 36 is formed at the top end of the small diameter portion 33. The recess 36 is used as a mounting seat for the second seal member 7. The backup ring 35 is installed next to the second seal member 7.

The pressure container 1A according to this modification can also gain the same effects as those by the pressure container 1 according to the first embodiment. In addition, the second seal member 7 of the pressure container 1A can seal a gap between the mouthpiece 3 and the valve 5A. The pressure container 1A has the second seal member 7 besides the first seal member 6, further improving the seal performance. For example, when hydrogen is stored in the pressure container 1A, an engaging portion between the mouthpiece and the valve may be embrittled by hydrogen to cause the fastening force of the thread to be reduced. However, according to the present embodiment, the valve 5A can stop the hydrogen from flowing at the top end to deter embrittlement by the hydrogen, that is, the hydrogen embrittlement can be prevented.

In the embodiment and the modification described above, a seal member may be further provided between the intermediate portion 23 of the mouthpiece 3 and the middle diameter portion 32 of the valve 5.

### Second Embodiment

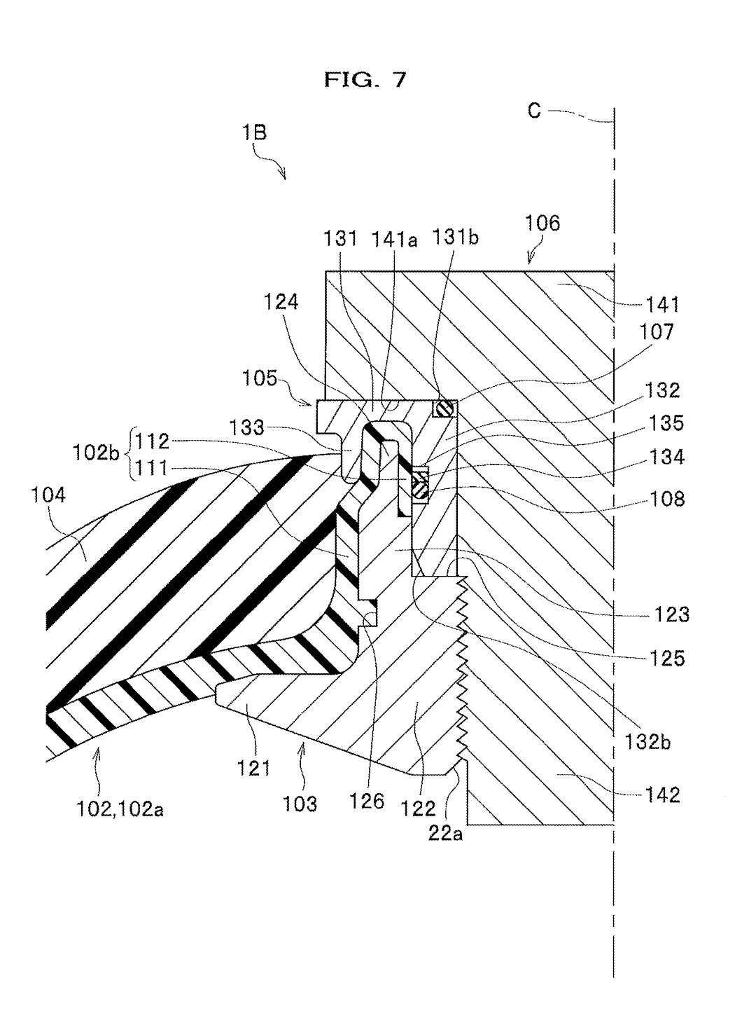

Next, a pressure container 1B according to a second embodiment of the present invention will be described with reference to FIG. 7 and so on. The pressure container 1B mainly includes a liner 102, a mouthpiece 103, a reinforcing layer 104, an attachment member 105, a valve 106, a first seal member 107 and a second seal member 108.

The liner 102 includes a storage portion 102a and a filler neck 102b. The liner 102 has substantially the same structure as the liner 2 according to the first embodiment. The filler neck 102b is formed with a neck portion 111 and a folded portion 112.

As shown in FIG. 7, the filler neck 102b is formed with a cylindrical neck portion 111 continuous to the storage portion 102a, and a folded portion 112 folded from the top end of the neck portion 111 toward the storage portion 102a.

The neck portion 111 is in contact with the outer circumferential faces of a base portion 122, an intermediate portion 123 and an embedded portion 124 to be described later. The folded portion 112 has an L-shaped cross section and is extended from the top end of the neck portion 111 toward the storage portion 102a. The folded portion 112 is in contact with the top end face and the inner circumferential face of the embedded portion 124 to be described later.

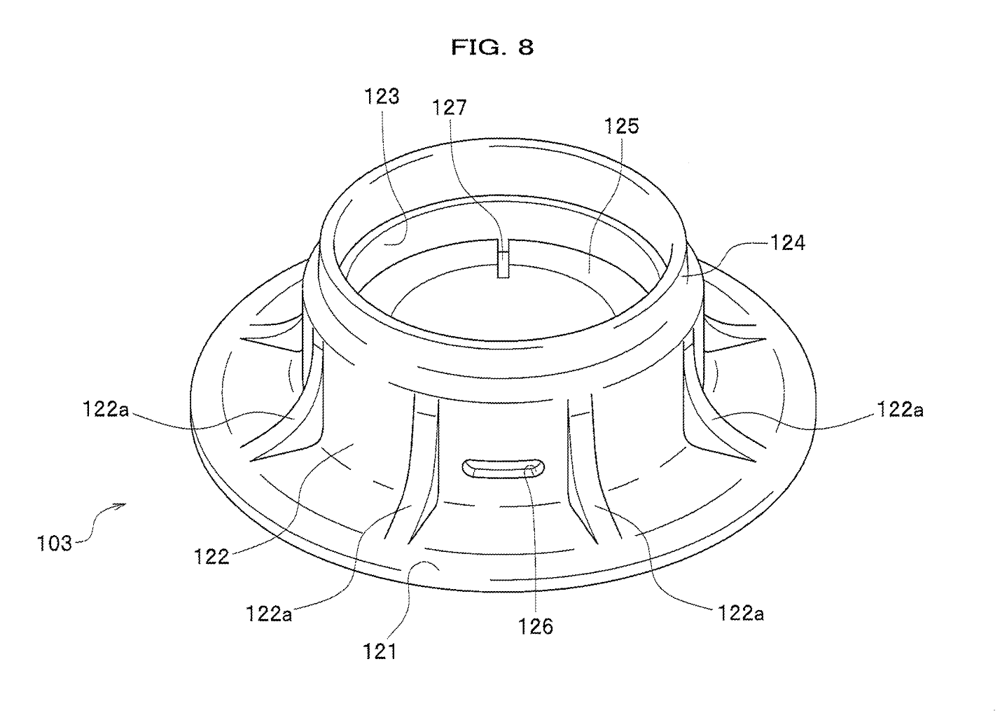

As shown in FIGS. 7 and 8, the mouthpiece 103 is a metal member arranged radially inside the liner 102. The mouthpiece 103 is mainly formed with a flange 121, the base portion 122, the intermediate portion 123 and the embedded portion 124.

The flange 121 has an annular shape. The base portion 122 has a cylindrical shape and is extended from the inner edge of the flange 121. A female thread is formed in the inner circumferential face of the base portion 122. A plurality of grooves 126 are formed along the circumferential direction on the outer circumferential face of the base portion 122 (only one groove 126 is shown in FIG. 8). Further, a plurality of ribs 122a are formed to protrude outward on the flange 121 and the base portion 122. The ribs 122a are formed at regular intervals in the circumferential direction. The resin for forming the liner 102 later penetrates into the grooves 126 and spaces between adjacent ribs 122a, 122a to regulate the relative rotation to the filler neck 102b and the movement in the center axis C direction of the mouthpiece 103.

The intermediate portion 123 has a cylindrical shape and is formed at the top end of the base portion 122. The intermediate portion 123 is thinner than the base portion 122. The intermediate portion 123 has a larger inner diameter than the base portion 122. A stepped face 125 is formed at the stepped portion between the base portion 122 and the intermediate portion 123. A pair of grooves 127 radially facing each other is formed in the stepped face 125 (only one groove 127 is shown in FIG. 8). Protrusions 132a of the attachment member 105 to be described later are fitted into the grooves 127.

As shown in FIG. 7, the “exposed portion” in claims is a portion formed with the base portion 122 and the intermediate portion 123.

The embedded portion 124 has a cylindrical shape and is formed on the top end face of the intermediate portion 123. The embedded portion 124 is thinner than the intermediate portion 123. The embedded portion 124 has a larger inner diameter than the intermediate portion 123. As shown in FIG. 7, the radially outer and inner faces and the end of the embedded portion 124 are covered continuously by the neck portion 111 and the folded portion 112 in the circumferential direction.

The reinforcing layer 104 is made of FRP (fiber reinforced plastic) and is formed to cover the outer circumference of the liner 102. The reinforcing layer is not limited to the fiber reinforced resin, and may be formed of other materials that can improve the strength of the liner 102.

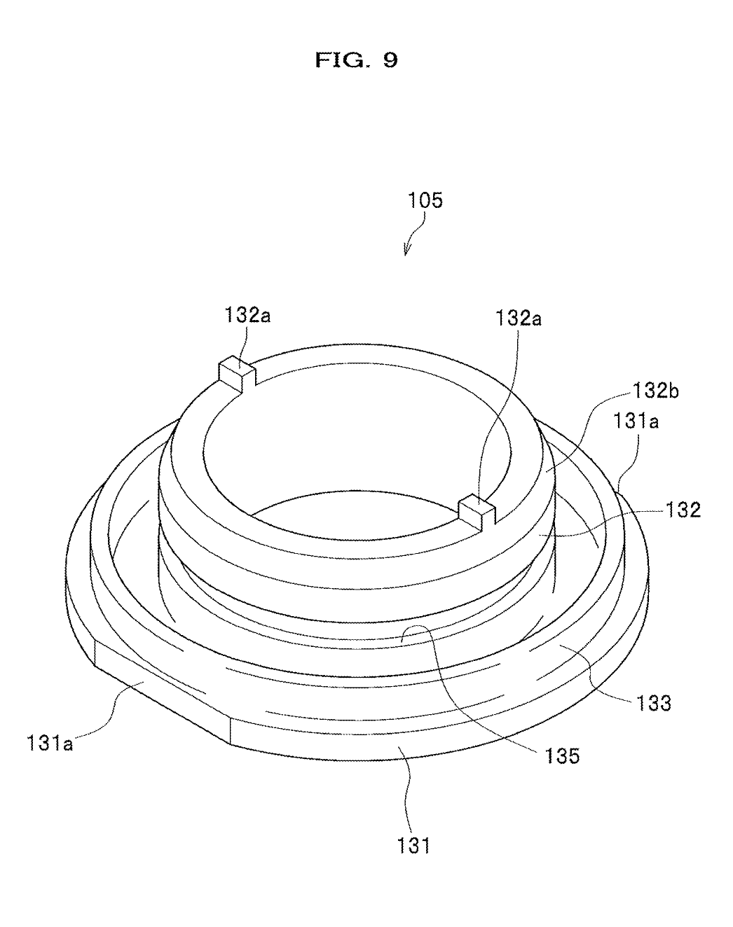

As shown in FIGS. 7 and 9, the attachment member 105 is a metal member attached to the filler neck 102b and the top end (end) of the mouthpiece 103. The attachment member 105 is formed with a base portion 131, an inner wall portion 132 and an outer wall portion 133.

The base portion 131 has an annular shape. A pair of cut faces 131a is formed on the outer edge of the base portion 131 for applying a rotating tool. A groove 131b is formed along the circumferential direction in the inner edge of the base portion 131. A first seal member 107 is arranged in the groove 131b.

The inner wall 132 has a tubular shape, and extends substantially perpendicular to the base portion 131 from the inner edge of the base portion 131. The inner diameter of the inner wall portion 132 is substantially the same as the the outer diameter of a small diameter portion 142 of the valve 106 to be described later. The outer diameter of the inner wall portion 132 is substantially the same as the inner diameter of the folded portion 112. A recess 135 is formed along the circumferential direction on the outer circumferential face of the inner wall portion 132. The recess 135 is used as a mounting seat for the second seal member 108. As shown in FIG. 9, the pair of protrusions 132a is formed on the top end face of the inner wall portion 132. The protrusions 132a have a shape to be fitted into the grooves 127. Also, a chamfered portion 132b is formed outside the top end of the inner wall portion 132. The chamfered portion 132b allows the attachment member 105 to be easily inserted into the filler neck 102b.

The outer wall portion 133 has a cylindrical shape and is extended substantially perpendicular to the base portion 131 radially outside the inner wall portion 132. The outer wall portion 133 is shorter in height than the inner wall portion 132. As shown in FIG. 7, the inner diameter of the outer wall portion 133 is substantially the same as the outer diameter of the top end of the neck portion 111. The filler neck 102b is fitted between the inner wall portion 132 and the outer wall portion 133.

As shown in FIG. 7, the valve 106 is inserted into the inner wall portion 132 of the attachment member 105 as well as the inside of the mouthpiece 103. The valve 106 is formed with a main portion 141 and the small diameter portion 142. An end face 141a of the main portion 141 is in contact with the base portion 131 of the attachment member 105.

The small diameter portion 142 has a smaller outer diameter than the main portion 141. The outer circumferential face of the small diameter portion 142 is flat at the base end. A male thread is formed on the outer circumferential face of the small diameter portion 142 at the top end, to be screwed with the base portion 122.

The first seal member 107 is an O-ring and is arranged in the groove 131b. The first seal member 107 is used to seal a gap between the attachment member 105 and the valve 106. The first seal member 107 is, specifically, in contact with the base portion 131 and the end face 141a.

The second seal member 108 is an O-ring and is arranged in the recess 135. The second seal member 108 is used to seal a gap between the filler neck 102b and the attachment member 105. The second seal member 108 is, specifically, in contact with the folded portion 112 and the inner wall portion 132. The second seal member 108 is arranged to be overlapped with the folded portion 112 and the embedded portion 124 in the center axis C direction. In this embodiment, a backup ring 134 is arranged adjacent to the second seal member 108.

Next, a method of manufacturing the pressure container according to the present embodiment will be described. The pressure container according to the present embodiment is manufactured by blow molding. The manufacturing method of the pressure container includes an arrangement process, a parison supply process, a mold clamping process, a blow process, an attachment mounting process, a reinforcing layer forming process, and a component mounting process. Since the processes from the arrangement process to the blow process are equivalent to those in the first embodiment, detailed descriptions thereof will be omitted.

In the attachment mounting process, while the second seal member 108 and the backup ring 134 are mounted in the recess 135, the attachment member 105 is attached on the top end of the liner 102 of the composite member formed with the liner 102 and the mouthpiece 103. Specifically, the top end of the filler neck 102b is fitted into a gap between the inner wall portion 132 and the outer wall portion 133 of the attachment member 105.

In the reinforcing layer forming process, the reinforcing layer 104 is formed on the outer circumferences of the liner 102 and the attachment member 105, for example, by a filament winding process.

In the component mounting process, the first seal member 107 is mounted on the small diameter portion 142 of the valve 106 or is arranged in the groove 131b. Then, the valve 106 is inserted into the attachment member 105 to be screwed in the mouthpiece 103. With the processes mentioned above, the pressure container 1B is formed. It is noted that the manufacturing method of the pressure container 1B is not limited to the method described above, and for example, the attachment member 105 may be attached after the reinforcing layer 104 is formed.

According to the pressure container 1B described above, the filler neck 102b can easily be worn due to aging degradation because it is made of resin and protrudes, however, the embedded portion 124 of the mouthpiece 103 is embedded along the circumferential direction inside the end of the filler neck 102b and the exposed portion (the base portion 122 and the intermediate portion 123) of the mouthpiece 103 is formed as the inner wall of the filler neck 102b. As a result, the filler neck 102b is reinforced. The second seal member 108 is arranged at a position to seal the reinforced filler neck 102b, that is, at a position to be overlapped with the folded portion 112 and the embedded portion 124 in the center axis C direction, allowing the second seal member 108 to securely seal the gap between the filler neck 102b and the attachment member 105 for a long time. Further, the structure can be simple because all that is required is to arrange the embedded portion 124 and the exposed portion inside the filler neck 102b.

The mounting member inclusive of the valve 106 attached to the mouthpiece 103 of the pressure container 1B, a joint member and the like has a variety of shapes and sizes. Therefore, the shape of the mouthpiece 103 needs to be changed in accordance with the change of the mounting member, and further, the forming molds and the manufacturing processes may need to be changed. However, as is the case with the present embodiment, the attachment member 105 is arranged on the top end of the mouthpiece 103, to allow the mouthpiece 103 to be applied to different types of mounting members, without changing the shape of the mouthpiece 103.

In addition, in the present embodiment, the first seal member 107 is arranged to seal the gap between the attachment member 105 and the valve 106.

### First Modification

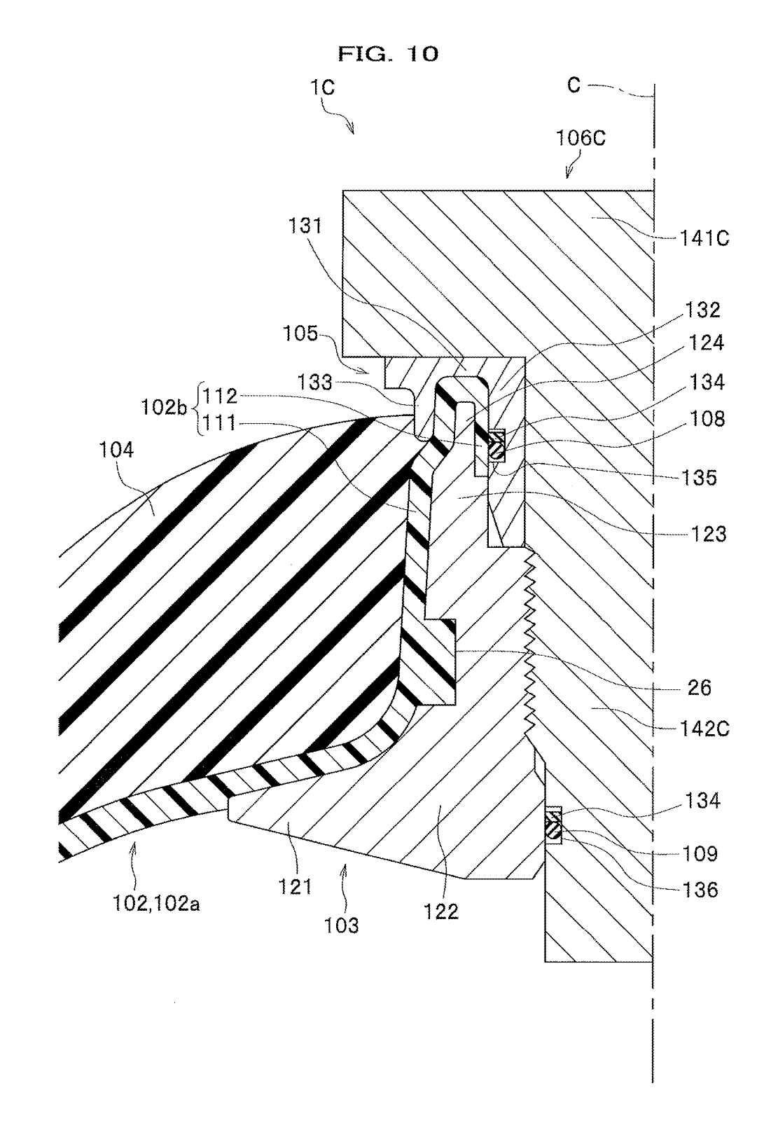

Next, a description will be given of a pressure container 1C according to a first modification of the second embodiment, referring to FIG. 10. As shown in FIG. 10, the pressure container 1C differs from the second embodiment in that a third seal member 109 is provided in addition to the second seal member 108. The first modification is substantially the same as the second embodiment except the elimination of the first seal member 107 (see FIG. 7) and the addition of the third seal member 109, therefore, the same portions are denoted by the same reference numerals and the explanations thereof will be omitted.

The base portion 122 of the mouthpiece 103 is formed with a female thread on its base end side of the inner circumferential face. In addition, the inner circumferential face on its top end side is flat. The top end side has a smaller inner diameter than the base end side.

The valve 106C is formed with a main portion 141C and a small diameter portion 142C. On the outer circumferential face of the small diameter portion 142C, the top end side and the base end side are flat, and the male thread is formed on the center portion.

A recess 136 is formed along the circumferential direction on the top end of the outer circumferential face of the valve 106C. The third seal member 109 is arranged in the recess 136. The backup ring 134 is arranged next to the third seal member 109.

The pressure container 1C according to the first modification can gain substantially the same effect as the pressure container 1B according to the second embodiment. Further, the third seal member 109 of the pressure container 1C can seal a gap between the mouthpiece 103 and the valve 106C. The pressure container 1C has the third seal member 109 in addition to the second seal member 108, allowing for improving the sealing performance. For example, when hydrogen is stored in the pressure container 1C, the engaging portion between the mouthpiece 103 and the valve 106c may be embrittled by hydrogen to cause the fastening force of the thread to be reduced. However, according to the present embodiment, the hydrogen can be stopped from flowing at the top end side of the valve 106C to prevent the hydrogen embrittlement from occurring. It is noted that the first seal member 107 used in the second embodiment may be further arranged in the pressure container 1C.

### Second Modification

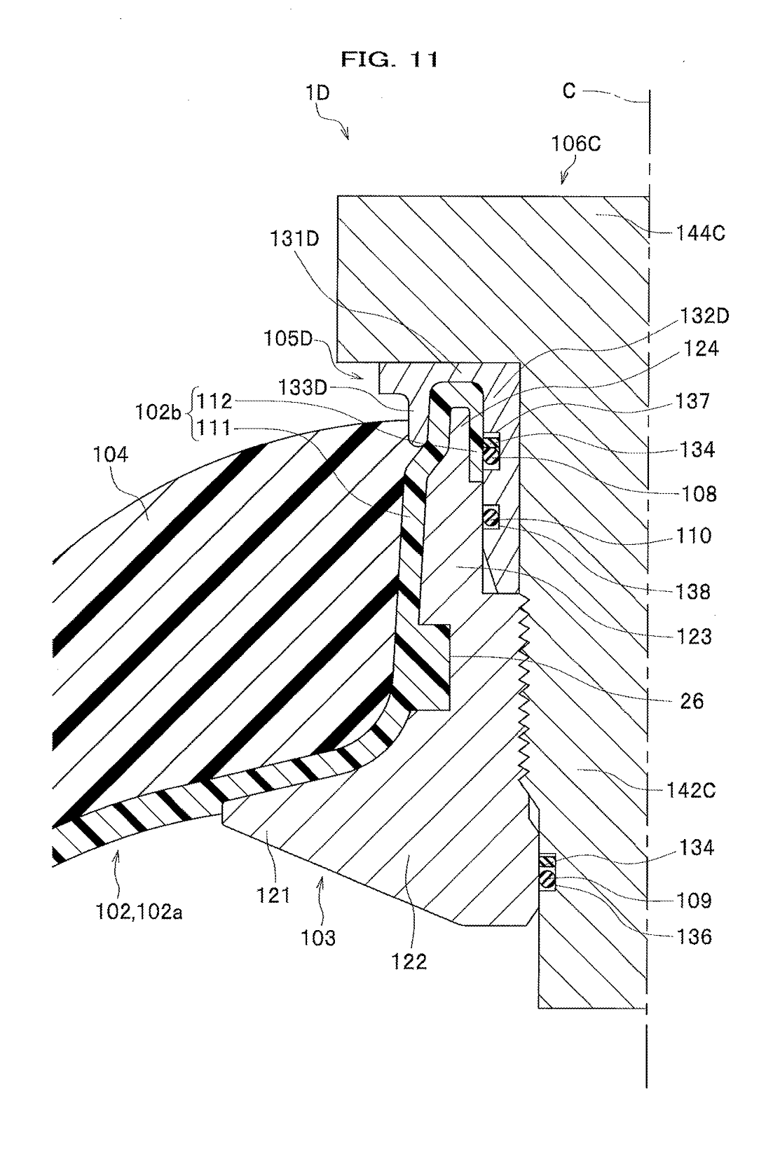

Next, a description will be given of a pressure container 1D according to a second modification of the second embodiment, referring to FIG. 11. As shown in FIG. 11, the pressure container 1D is different from the pressure container 1C according to the first modification in that the pressure container 1D includes a fourth seal member 110, in addition to the second seal member 108 and the third seal member 109. The pressure container 1D is substantially the same as the pressure container 1C according to the first modification except that the pressure container 1D has the fourth seal member 110, therefore, the same portions are denoted by the same reference numerals and the explanations thereof will be omitted.

The attachment member 105D is formed with a base portion 131D, an inner wall portion 132D and an outer wall portion 133D. On the outer circumferential face of the inner wall portion 132D, a first recess 137 is formed on its base end side, and a second recess 138 is formed on its top end side. The second seal member 108 and the backup ring 134 are arranged in the first recess 137. The fourth seal member 110 is arranged in the second recess 138. The fourth seal member 110 is used to seal a gap between the intermediate portion 123 and the inner wall portion 132D.

The pressure container 1D according to the second modification can gain substantially the same effect as that by the first modification. In addition, for example, when hydrogen is stored in the pressure container 1D, the fourth seal member 110 can further stop the hydrogen flowing along the liner 102 and the mouthpiece 103 from flowing toward the thread. Thus, hydrogen embrittlement at the thread portion can be further prevented.

### Third Modification

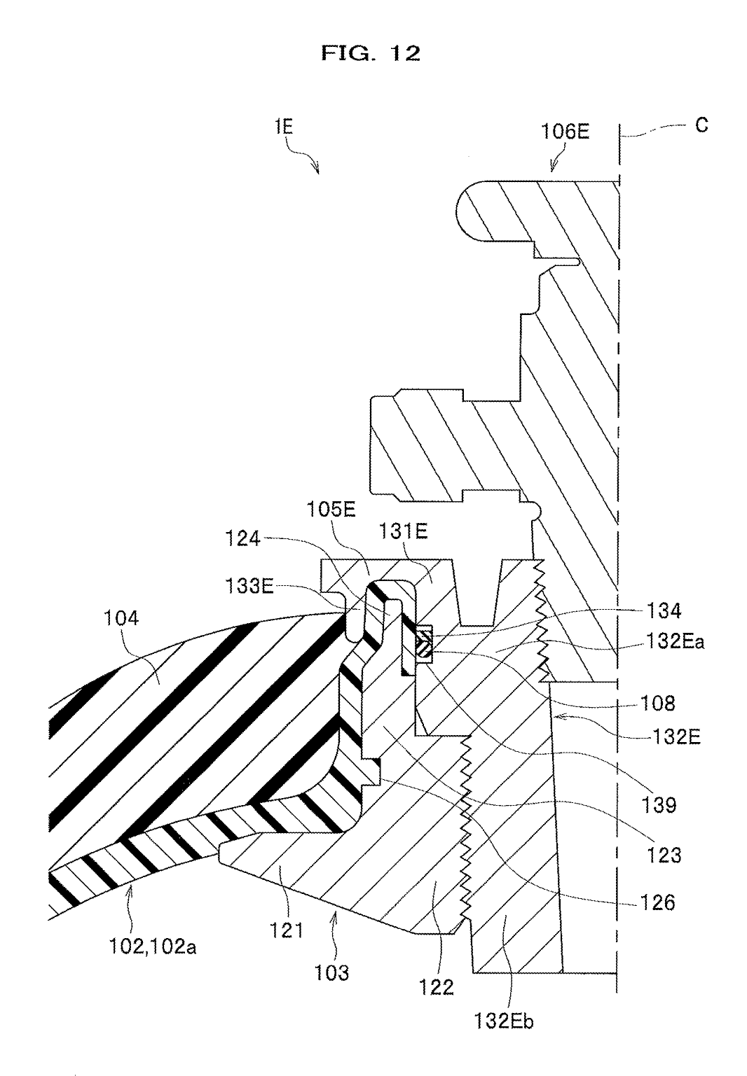

Next, a description will be given of a pressure container 1E according to a third modification of the second embodiment, referring to FIG. 12. As shown in FIG. 12, the pressure container 1E includes an attachment member 105E and a valve 106E having different shapes from those in the second embodiment.

The attachment member 105E is formed with a base portion 131E, an inner wall portion 132E and an outer wall portion 133E.

The inner wall portion 132E is formed with a large diameter portion 132Ea and a small diameter portion 132Eb. The large diameter portion 132Ea is extended perpendicular to the base portion 131E and has a cylindrical shape. A tapered female thread is formed on the inner circumferential face of the large diameter portion 132Ea. The outer circumferential face of the large diameter portion 132Ea is flat. A recess 139 is formed along the circumferential direction on the outer circumferential face of the large diameter portion 132Ea. The second seal member 108 and the backup ring 134 are mounted in the recess 139. A male thread is formed on the outer circumferential face of the small diameter portion 132Eb, to be screwed in the female thread of the base portion 122.

The pressure container 1E according to the third modification can gain substantially the same effect as that by the pressure container 1B according to the second embodiment. In addition, the attachment member 105E of the pressure container 1E has a smaller inner diameter than the attachment member 105 according to the second embodiment. If the outer diameter of a screwed portion is small as is the case with the valve 106E, the attachment member 105E can be used to solve such a size issue. The third modification exemplifies a general-purpose valve, and a seal tape is wound around the tapered thread of the valve 106E to seal a gap between the attachment member 105E and the valve 106E.

The embodiments and the modifications of the present invention have been described above, but the present invention can be appropriately changed in design without departing from the spirit of the present invention. For example, the portion where the base portion is screwed with the valve or the attachment member is screwed with the valve may be sealed with a seal tape as is the case with the third modification described above. Further, in the present embodiment, the valve is screwed with the mouthpiece or the attachment member, but may be fastened with other arrangement.

### EXPLANATION OF REFERENCES

1 pressure container
2 liner
2a storage portion
2b filler neck
3 mouthpiece
4 reinforcing layer
5 valve (mounting member)
6 first seal member (seal member)
7 second seal member (seal member)
11 neck portion
12 folded portion
21 flange
22 base portion
23 intermediate portion
24 embedded portion
102 liner
102a storage portion
102b filler neck
103 mouthpiece
104 reinforcing layer
105 attachment member
106 valve (mounting member)
107 first seal member (seal member)
108 second seal member (seal member)
109 third seal member (seal member)
110 fourth seal member (seal member)
K forming mold
P parison

1-3. (canceled)

4. A pressure container comprising:
a liner that includes a storage portion storing liquid or gas and a filler neck in a cylindrical shape protruding from the storage portion and that is formed as a single piece by blow molding;
a mouthpiece that includes an embedded portion embedded in a circumferential direction by the filler neck being folded inward in a radial direction at an end portion, and an exposed portion that is formed continuously from the embedded portion to be exposed as an inner wall of the filler neck;
an attachment member that is fitted with the end portion of the filler neck in the circumferential direction;
a mounting member that is mounted inside at least either one of the attachment member and the exposed portion in the radial direction;
a seal member that seals a gap between the filler neck and the attachment member; and
a reinforcing layer that is arranged outside the liner, wherein
the reinforcing layer is arranged outside the liner and the attachment member at the filler neck of the liner so that the liner is not exposed outside.

5. The pressure container according to claim 4, further comprising a seal member that seals a gap between the exposed portion and the mounting member.

6. The pressure container according to claim 4, further comprising a seal member that seals a gap between the exposed portion and the attachment member.

7. The pressure container according to claim 4, further comprising a seal member that seals a gap between the attachment member and the mounting member.

8. The pressure container according to claim 4, wherein the exposed portion has a base portion formed at a base end, an intermediate portion formed between the base portion and the embedded portion, and a stepped face formed with the base portion and the intermediate portion, and
a portion of the attachment member is in contact with the stepped face and an end face of a blow pin is in contact with the stepped face in the blow molding.

9. (canceled)

10. The pressure container according to claim 5, further comprising a seal member that seals a gap between the exposed portion and the attachment member.
